(19) United States
(12) Patent Application Publication
(10) Pub. No.: US 2018/0095319 A1
(43) Pub. Date: Apr. 5, 2018

(54) LIQUID CRYSTAL DISPLAY APPARATUS

(71) Applicant: Sakai Display Products Corporation, Osaka (JP)

(72) Inventor: Kouji MATSUMOTO, Osaka (JP)

(21) Appl. No.: 15/830,361

(22) Filed: Dec. 4, 2017

Related U.S. Application Data
(63) Continuation-in-part of application No. PCT/JP2015/066359, filed on Jun. 5, 2015.

(51) Int. Cl. G02F 1/1333; F21V 8/00

(52) U.S. Cl. CPC G02F 1/133308; G02F 2001/133328; G02F 2001/133317; G02B 6/005

(57) ABSTRACT

A liquid crystal display apparatus capable of sufficiently ensuring a holding surface for holding a liquid crystal panel in a panel chassis while ensuring space for elongation of an optical sheet is provided. The apparatus comprises: a liquid crystal panel for displaying an image on a front surface thereof; an optical sheet laminate composed of a plurality of optical sheets disposed on a rear surface of the liquid crystal panel, an optical sheet having a larger coefficient of thermal expansion than a portion of the optical sheets being laminated on the portion of the optical sheets; a panel chassis for holding the liquid crystal panel; and a protruded portion disposed on the panel chassis and having an inclined surface with a downward pitch extending from the side of the optical sheet having the larger coefficient of thermal expansion along a laminating direction of the optical sheet laminate.

### CROSS-REFERENCE TO RELATED APPLICATION

This is a continuation-in-part of PCT international application No. PCT/JP2015/066359 filed on Jun. 5, 2015, incorporated herein by reference.

### BACKGROUND OF THE INVENTION

The present disclosure relates to a liquid crystal display apparatus.

A liquid crystal display apparatus includes component members such as a liquid crystal panel, an optical sheet, a back light source, a light guiding plate, and those component members can be retained by various frame bodies. The frame bodies include a panel chassis. The panel chassis is disposed on an outer periphery of the liquid crystal panel, the optical sheet and the light guiding plate, which form a laminated structure in this order from a front surface, and includes a flat plate portion protruding to its center. The flat plate portion is circumferentially provided between an outer periphery of a rear surface of the liquid crystal panel and an outer periphery of a front surface of the light guiding plate, and an end surface of the flat plate portion is in proximity with an outer periphery of the optical sheet. A front surface of the flat plate portion functions as a retaining surface to retain the liquid crystal panel by abutting against the rear surface of the liquid crystal panel.

There has been developments in attaining a thickness reduction and a narrow frame of a liquid crystal display apparatus. JP 2014-123122 A discloses a liquid crystal display apparatus, for which the thickness reduction was achieved by adopting a panel chassis made by combining two different parts, so that realizing a thinner apparatus while ensuring a retaining surface of a panel chassis being sufficient for retaining a liquid crystal panel.

### SUMMARY OF THE INVENTION

### Problems to be Solved by the Invention

On the other hand, there is a problem that an optical sheet will be expanded due to heat emitted from a light source of a back light when operating a liquid crystal display apparatus for a long time. If the optical sheet is expanded, a peripheral part of the optical sheet may contact with the end surface of the flat plate portion, causing a deformation of the optical sheet. This could lead a unexpected reflection of the light entered into the optical sheet or a reduction of an amount of the light that enters into the optical sheet due to the space generated between the optical sheet and the panel chassis, resulting in a deterioration of a display quality of the liquid crystal display apparatus.

In order to avoid a deformation of the optical sheet caused by thermal expansion, a certain size of space has been provided between the outer periphery of the optical sheet and the end surface of the flat plate portion. However, the width of the protrusion part of the flat plate portion should be formed short in order to ensure a sufficient space for the expansion, and this may cause a problem that a sufficient surface for retaining the liquid crystal panel cannot be ensured.

The present invention has been made in view of such circumstances as mentioned above, and an object of the present invention is to provide a liquid crystal display apparatus in which a sufficient retaining space for retaining the liquid crystal as well as a sufficient space for the optical sheet to be expanded can be ensured.

### Means to Solve the Problems

A liquid crystal display apparatus according to one embodiment of the present application comprises:

a light guiding plate; an optical sheet laminate comprising a first optical sheet and a second optical sheet laminated on a light-emitting surface of the light guiding plate, the second optical sheet having a higher coefficient of thermal expansion than that of the first optical sheet; a liquid crystal panel disposed on the optical sheet laminate and displaying an image on a front surface thereof; and a panel chassis comprising a flat plate portion, the flat plate portion having a front surface abutting against a circumferential part of a rear surface of the liquid crystal panel and a rear surface abutting against a circumferential part of a front surface of the light guiding plate, wherein an end surface of the flat plate portion has an inclined surface, the end surface of the flat plate portion being opposed to an end surface of the optical sheet laminate disposed between the light guiding plate and the liquid crystal panel, and wherein the inclined surface is formed in such a manner that the end surface of the flat plate portion is farther from an end surface of the first optical sheet of the optical sheet laminate than an end surface of the second optical sheet of the optical sheet laminate.

In another embodiment of a liquid crystal display apparatus of the present application, the second optical sheet is disposed in the neighborhood of the liquid crystal panel, and the first optical sheet is disposed in the neighborhood of the light guiding plate.

In yet another embodiment of a liquid crystal display apparatus according to the present application, a slit is provided at a peripheral portion of the second optical sheet.

More specifically, when the second optical sheet has two short sides and two long sides, and the end surface of the second optical sheet opposed to the end surface of the flat plate portion is one of the short sides, the slit is formed in the neighborhood of the one of the short sides from one of the two long sides to the other of the two long sides in a form of a dotted line.

In yet another embodiment of a liquid crystal display apparatus according to the present application, the second optical sheet is a rectangular sheet having two short sides and two long sides, and the end surface of the second optical sheet opposed to the end surface of the flat plate portion is one of the short sides, and the slit is formed in the neighborhood of the one of the short sides.

The slit may be formed substantially in parallel to the short side.

In the presently illustrated embodiments, when the optical sheet is expanded by the thermal expansion, the peripheral part of the expanded optical sheet can bend along the inclined surface of the panel chassis. Therefore, the peripheral part of the expanded optical sheet is received in the above-mentioned space, and thus preventing the optical sheet from being deformed irregularly. Therefore, a sufficient space for the optical sheet to be expanded can be ensured while ensuring a sufficient retaining surface to the panel chassis for retaining the liquid crystal panel.

### BRIEF DESCRIPTION OF THE DRAWINGS

FIG. 1 shows a general perspective view of a liquid crystal display apparatus.

FIG. 2 shows a break-up perspective view of a liquid crystal display apparatus.

FIG. 3 shows a cross-sectional view of a short side portion of a liquid crystal display apparatus.

FIG. 4 shows a cross-sectional view of one of the long side portion of a liquid crystal display apparatus.

FIG. 5 shows a schematic partial perspective view of a panel chassis.

FIG. 6 shows a partial cross-sectional view of a liquid crystal display apparatus when an optical sheet laminate is thermally expanded.

FIG. 7 shows a front view of a second optical sheet according to Embodiment 2.

FIG. 8 shows a cross-sectional view of a flat plate portion of a panel chassis according to Embodiment 3.

FIG. 9 shows a cross-sectional view of a flat plate portion of a panel chassis according to Embodiment 4.

FIG. 10 shows a cross-sectional view of a flat plate portion of a panel chassis according to Embodiment 5.

### DETAILED DESCRIPTION

The invention will be further described below in terms of several embodiments and particularly in terms of drawings showing some embodiments.

### Embodiment 1

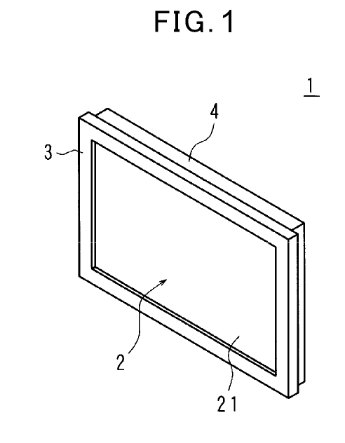

FIG. 1 shows a general perspective view of a liquid crystal display apparatus 1. Here, a surface on which a liquid crystal panel 2 displays an image is referred to as a front of liquid crystal display apparatus 1 and an opposite surface is referred to as a rear of liquid crystal display apparatus 1. The liquid crystal display apparatus 1 includes a liquid crystal panel 2, a bezel 3 and a back light chassis 4. The liquid crystal panel 2 may be a horizontally long, substantially rectangular flat plate and includes a display surface 21 on the front, on which an image is displayed. The back light chassis 4 may have a substantially rectangular, box-shaped body with an opening on the front surface and covers a rear portion of the light guiding plate 7. The bezel 3 may have a horizontally long, rectangular-shaped frame body, which is substantially L-shaped in a cross-sectional view along the direction perpendicular to extending direction, and covers a front peripheral part of the liquid crystal panel 2 and an outer surface of the back light chassis 4. The bezel 3 and the back light chassis 4 are locked with each other in a way where, for example, a locking claw is provided with either of the bezel 3 and the back light chassis 4 and a locking groove with the other.

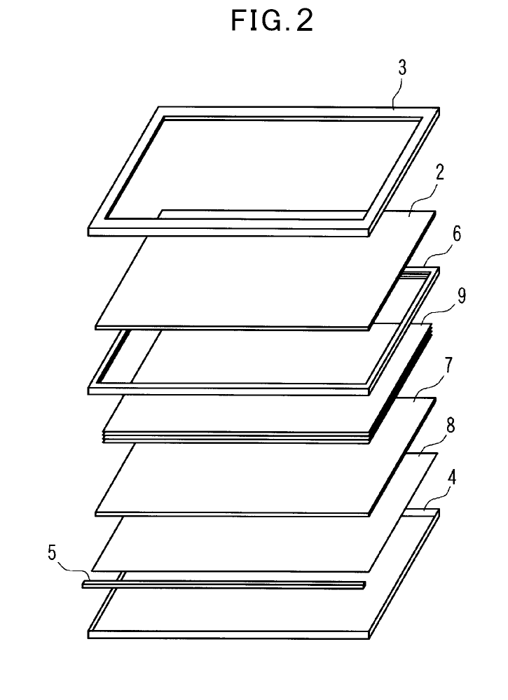

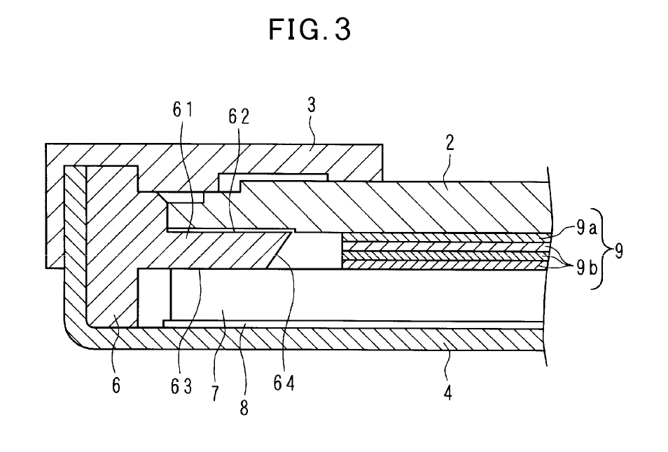

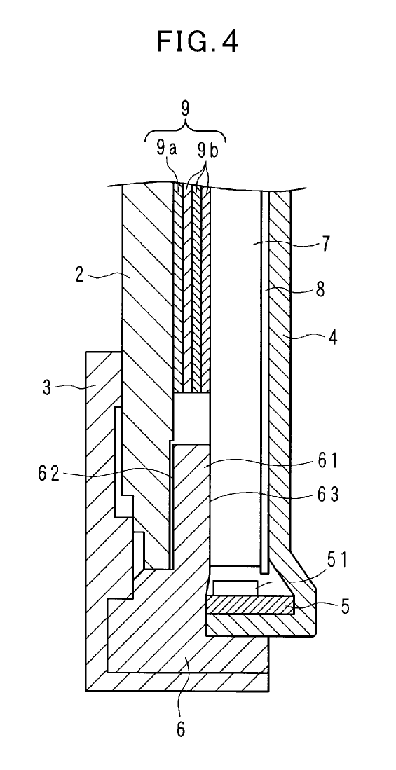

FIG. 2 shows a break-up perspective view of the liquid crystal display apparatus 1. FIG. 3 shows a cross-sectional view of a short side of the liquid crystal display apparatus 1. FIG. 4 shows a cross-sectional view of one of the long side of the liquid crystal display apparatus 1. The upward direction in FIG. 3 and the left direction in FIG. 4 correspond to the front direction of the liquid crystal display apparatus 1. The liquid crystal display apparatus 1 includes an LED substrate 5, a panel chassis 6, a light guiding plate 7, a reflection sheet 8 and an optical sheet laminate 9 along with the liquid crystal panel 2, the bezel 3 and the back light chassis 4.

The back light chassis 4 may be, as described above, a substantially rectangular, box-shaped body, which is, for example, a press-molded article made of, for example, steel or aluminum. As shown in FIG.3 and FIG. 4, on the back light chassis 4 the liquid crystal panel 2, the optical sheet laminate 9, the light guiding plate 7 and the reflection sheet 8 are placed in this order from the front and held inside the back light chassis. Further, as shown in FIG. 4, the LED substrate 5 is disposed on the inside of the long side of the back light chassis 4, such that it faces to an edge of long side portion of the light guiding plate 7.

The light guiding plate 7 may be a rectangular-shaped plate having a front surface and a rear surface, made of, for example, acryl. A length of each side of the front surface of the light guiding plate 7 may be substantially same as each of the corresponding sides of the rear surface of the liquid crystal panel 2 and each of the corresponding sides of the optical sheet laminate 9. Light radiated by LED 51, which is described below, enters into the light guiding plate 7 through the edge and is diffused by the light guiding plate 7, and diffused light is emitted from a light-emitting surface of the light guiding plate 7 to the optical sheet laminate 9.

The reflection sheet 8 may be provided opposite to the inner front surface (the bottom surface) of the back light chassis 4 and may have a substantially rectangular body. The reflection sheet 8 may be made of, for example, a synthetic resin having a high reflectivity. The reflection sheet 8 reflects the light, which is emitted from the rear surface of the light guiding plate 7, to the front to effectively use the light that is radiated by LED 51.

The LED substrate 5 may be an elongate, plate-shaped member. As shown in FIG. 4, a plurality of LEDs 51 may be mounted on the LED substrate 5, and light radiated by the LED 51 enters into the light guiding plate 7 through the edge of the light guiding plate 7.

In the presently illustrated embodiment, an exemplary embodiment in which the liquid crystal display apparatus 1 is so-called an edge-light type and includes a light source positioned opposite to one of the edges of the light guiding plate 7 is described, however, it should be understood that that the apparatus can have different configurations, for example, a configuration in which a diffusing plate is provided instead of the light guiding plate 7 and the light source is disposed at the rear of the diffusing plate, providing a so-called direct light type light source apparatus.

The optical sheet laminate 9 is a laminate obtained by laminating a plurality of optical sheets. Each of the optical sheets of the optical sheet laminate 9 may be a substantially rectangular-shaped sheet, and a length of each side may be substantially same as a length of each of the respective sides of the front surface of the light guiding plate 7, or, more specifically, slightly shorter than each of the respective sides of the front surface of the light guiding plate 7. Similarly, a length of each side of the optical sheets of the optical sheet laminate 9 can be slightly shorter than each of the respective sides of the rear surface of the liquid crystal panel 2. The optical sheet laminate 9 may include, for example, one reflection polarizing sheet, one diffusing sheet and two prism sheets. It should be understood that the optical sheet laminate 9 can have different configurations, for example, a configuration in which a viewing angle expanding sheet is included to widen a range of a view angle.

The optical sheet laminate 9 may be configured to have a laminated structure comprising a part of the optical sheets (hereinafter referred to a first optical sheet) and the other part of the optical sheets (hereinafter referred to a second optical sheet) having a coefficient of thermal expansion higher than that of the part of the optical sheets. The optical sheets having a higher coefficient of thermal expansion may be disposed in the neighborhood of the liquid crystal panel 2 and the part of optical sheets may be disposed in the neighborhood of the light guiding plate 7. In this embodiment, for the purpose of facilitating understanding, an optical sheet having a higher coefficient of thermal expansion is referred to as a second optical sheet 9a, and an optical sheet of the part of optical sheets is referred to as a first optical sheet 9b. Further, in the presently illustrated exemplary embodiments, the second optical sheets 9a includes one optical sheet, and the first optical sheet includes more than one optical sheet. The second optical sheet 9a has higher coefficient of thermal expansion than the first optical sheet 9b, and therefore, when the optical sheet laminate 9 is expanded due to thermal expansion, the second optical sheet 9a expands more compared to the first optical sheet 9b.

The panel chassis 6 may have a substantially rectangular-shaped frame, and may be made of, for example, a synthetic resin. As shown in FIG. 3 and FIG. 4, the panel chassis 6 is disposed so as to cover an outer periphery of the laminated liquid crystal panel 2, optical sheet laminate 9, light guiding plate 7 and reflection sheet 8. Further, as shown in FIG. 3, an outer surface of the panel chassis 6 abuts against the inner surface of the back light chassis 4 at the short side portion of the liquid crystal display apparatus 1 (see FIG. 1). Furthermore, as shown in FIG. 4, the inner surface of the panel chassis 6 abuts against the outer surface of the back light chassis 4 in the long side portion of the liquid crystal display apparatus 1.

It should be understood that the panel chassis 6 can have different configurations, for example, a configuration in which a frame body can be constituted in the substantially rectangular-shape by combining four of elongated rod materials instead of using a frame body.

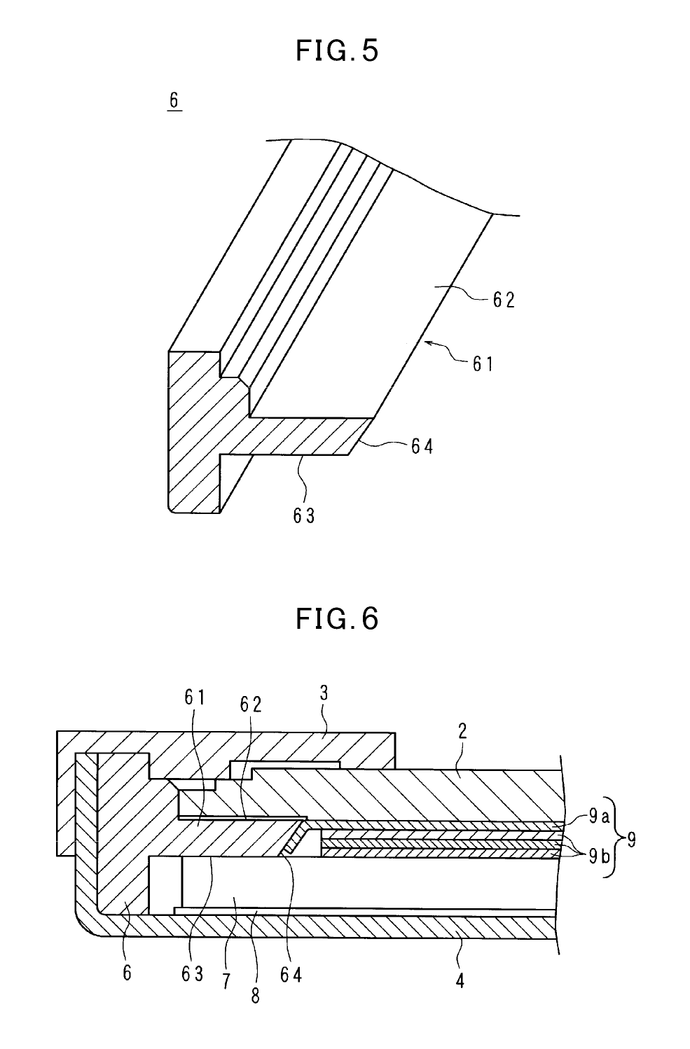

FIG. 5 shows a schematic partial perspective view of the panel chassis 6. FIG. 5 shows the short side portion of the panel chassis 6. In FIG. 5, the upward direction is the front direction. The hatched portion indicates a cross-section of the corresponding short side portion. The panel chassis 6 according to the presently illustrated embodiment includes a flat plate portion 61, that protrudes toward the optical sheet laminate 9, on inner surface. The flat plate portion 61 may be provided on whole periphery of the panel chassis 6, and include a front surface 62 and a rear surface 63 which are in parallel with each other. The end surface of the flat plate portion 61, protruding toward the optical sheet laminate 9, forms an inclined surface 64, which is inclined from the front surface 62 in the direction away from the optical sheet laminate 9 to the rear surface 63 of the flat plate portion 61. In the presently illustrated embodiment, the exemplary inclined surface 64 is a planar surface inclined at a certain fixed angle.

Returning to FIG. 3, in the state where the panel chassis 6 is incorporated into the liquid crystal display apparatus 1 (see FIG. 1), the flat plate portion 61 is located between the outer periphery of the rear surface of the liquid crystal panel 2 and the outer periphery of the front surface of the light guiding plate 7. The thickness of the flat plate portion 61 may be substantially same as the thickness of the optical sheet laminate 9. The width of the protruded part of the flat plate portion 61 can be slightly shorter than half of the difference in a length between the long side of the rear surface of the liquid crystal panel 2 and the long side of the optical sheet laminate 9.

The front surface 62 of the flat plate portion 61 is substantially in parallel with the rear surface of the liquid crystal panel 2, and abuts against the outer periphery of the rear surface of the liquid crystal panel 2. The rear surface 63 of the flat plate portion 61 is substantially in parallel with the front surface of the light guiding plate 7, and abuts against the outer periphery of the front surface of the light guiding plate 7.

The inclined surface 64 is inclined along a lamination direction of the optical sheet laminate 9, in such a manner that the end surface of the flat plate portion 61 is farther from the end surface of the first optical sheet 9b of the optical sheet laminate 9 than the end surface of the second optical sheet 9a of the optical sheet laminate 9. That is, in the inclined surface 64, a position where the inclined surface 64 confronts the end surface of the second optical sheet 9a of the optical sheet laminate 9 is closer to the optical sheet laminate 9 than a position where the inclined surface 64 confronts an end surface of the first optical sheet 9b of the optical sheet laminate 9. Further, since the width of the protrusion part of the flat plate portion 61 is slightly shorter than half of the difference in a length between the long side of the rear surface of the liquid crystal panel 2 and the long side of the optical sheet laminate 9, there provided is a small space between the inclined surface 64 and the optical sheet laminate 9, thus the inclined surface 64 may not be in contact with the optical sheet laminate 9.

In the presently illustrated embodiment, the apparatus can have a different configuration, for example, a configuration in which an optical sheet having a higher coefficient of thermal expansion is disposed opposite to the light guiding plate 7 and a optical sheet having a lower coefficient of thermal expansion is disposed opposite to the liquid crystal panel 2, and the inclined surface 64 is provided in a way that it is inclined from the rear surface 63 in the direction away from the optical sheet laminate 9 to the front surface 62 of the flat plate portion 61.

As shown in FIG. 3 and FIG. 4, the bezel 3 is disposed on the circumferential part of the display surface 21 of the liquid crystal panel 2, so that the rear surface of the bezel 3 abuts against the circumferential part of the front surface of the liquid crystal panel 2 as well as a part of the surface of the panel chassis 6. Now focusing on the liquid crystal panel 2, the bezel 3 and the panel chassis 6, those component members come into contact with each other, and therefore, the circumferential part of the liquid crystal panel 2 is sandwiched and fixed between the bezel 3 and the panel chassis 6. Further, the bezel 3 and the back light chassis 4 are locked to each other, then the back light chassis 4 and the panel chassis 6 come into contact with each other. Therefore, the liquid crystal panel 2 is sandwiched by the bezel 3 and the back light chassis 6.

Next, the thermal expansion of the optical sheet laminate 9 will be briefly described below. As described above, the LED 51 of the liquid crystal display apparatus emits light into the light entering surface of the light guiding plate 7. The LED 51 generates heat while the LED 51 emits light. The generated heat may be transmitted to the optical sheet laminate 9 through the light guiding plate 7 to warm the optical sheet laminate 9. The optical sheet laminate 9, which is generally composed of a polymer material such as a synthetic resin, will expand due to this temperature elevation and expansion will take place toward the outer periphery. In the presently illustrated embodiment, the optical sheet laminate 9 is an elongate sheet, therefore, the amount of expansion is larger in a long side direction compared to a short side direction.

FIG. 6 shows a partial cross-sectional view of the exemplary liquid crystal display apparatus 1 when the optical sheet laminate 9 is thermally expanded. FIG. 6 shows a cross-sectional view of the short side portion of the liquid crystal display apparatus 1 in the same manner as in FIG. 3. Comparison of FIG. 3 with FIG. 6 shows that the second optical sheet 9a of the optical sheet laminate 9 is expanded due to thermal expansion. In the presently illustrated embodiment, the coefficient of thermal expansion of the second optical sheet 9a is higher than the coefficient of thermal expansion of the first optical sheet 9b, and therefore, the second optical sheet 9a is expanded more outward compared to the first optical sheet 9b. A peripheral portion of the expanded second optical sheet 9a contacts with the inclined surface 64 and is bent along the inclined surface 64. Thus, the peripheral portion of the second optical sheet 9a expands to the space between the outer periphery of the first optical sheet 9b and the inclined surface 64. A peripheral of the optical sheet laminate 9 can be accommodated in the space without causing irregular deformation.

According to the exemplary configuration of Embodiment 1, in which the panel chassis 6 and the optical sheet laminate 9 are in proximity with each other, when the optical sheet laminate 9 is expanded due to thermal expansion, the peripheral portion of the second optical sheet 9a having a higher coefficient of thermal expansion comes into contact with the inclined surface 64 and is bent along the inclined surface 64. The peripheral portion of the expanded second optical sheet 9a is accommodated in the space between the first optical sheet 9b and the inclined surface 64.

In the case where the inclined surface 64 is not provided on the panel chassis 6, unlike the above-mentioned examples, the peripheral portion of the second optical sheet 9a will not be bent in a certain fixed direction, and will come into contact with the panel chassis 6, causing an irregular deformation of the second optical sheet 9a. As a result, the light that enters into the optical sheet laminate 9 is refracted unexpectedly, or a space is generated between the optical sheet laminate 9 and the panel chassis 6 and a part of the incident light does not enter into the optical sheet laminate 9, resulting in deterioration of a picture quality of the liquid crystal display apparatus 1.

On the other hand, in Embodiment 1, even if only a small space is secured between the panel chassis 6 and the optical sheet laminate 9, the irregular deformation may not be caused. Therefore, a sufficient space for expansion of the optical sheet laminate 9 can be secured while ensuring a sufficient front surface 62 on the panel chassis 6 for retaining the liquid crystal panel 2.

Further, according to Embodiment 1, the inclined surface 64 is inclined such that the a space between the optical sheet laminate 9 and the front surface 62 of the flat plate portion 61 is smaller than the space between the first optical sheet 9b and the rear surface 63 of the flat plate portion 61. In other words, the front surface 62 of the flat plate portion 61 is more protruded compared to the rear surface 63 of the flat plate portion 61. Therefore, as compared with an example in which the inclined surface 64 being inclined such that the length of the rear surface 63 of the flat plate portion 61 is longer than the length of the front surface 62 of the flat plate portion 61, a large front surface 62 for retaining the liquid crystal panel 2 on the panel chassis 6 can be provided.

Further, according to Embodiment 1, the inclined surface 64 is formed into a flat surface, thereby enabling the production of the panel chassis 6 easy.

Further, according to Embodiment 1, the inclined surface 64 can be provided on a part of a conventional panel chassis 6, therefore, there is no need for increasing the number of parts.

It should be noted that in Embodiment 1, the inclined surface 64 is provided on the short side portion of the panel chassis 6, but Embodiment 1 is not limited to such a configuration. Taking the expansion of the optical sheet laminate 9 along a direction of its short side into account, the inclined surface 64 may also be provided on the long side portion of the panel chassis 6.

Further, in Embodiment 1, the second optical sheet 9a is described as one of the optical sheets constituting the optical sheet laminate 9. However, Embodiment 1 is not limited to such a configuration, and the optical sheet laminate 9 may include two or more of the second optical sheets 9a. Even in such a case, the peripheral portion of the second optical sheet 9a expanded due to thermal expansion can be bent along the inclined surface 64.

Further, in Embodiment 1, since the liquid crystal panel 2 is configured to be sandwiched between the bezel 3 and the panel chassis 6, if the liquid crystal panel 2 can be retained by the panel chassis 6, then the bezel may be no longer an essential component element. For example, when a television receiver is constituted by incorporating the liquid crystal display apparatus 1 according to Embodiment 1, the liquid crystal panel 2 may be retained by a front cabinet covering a circumferential part of a front surface of the television receiver and the panel chassis 6.

### Embodiment 2

In Embodiment 1, an exemplary embodiment is described in which the peripheral portion of the second optical sheet 9a having a higher coefficient of thermal expansion than the first optical sheet 9b is bent along the inclined surface 64. Embodiment 2 further describes an embodiment in which slits 209c are formed at the peripheral portion of the second optical sheet 9a in order to allow the peripheral portion of the second optical sheet 9a to bend more easily.

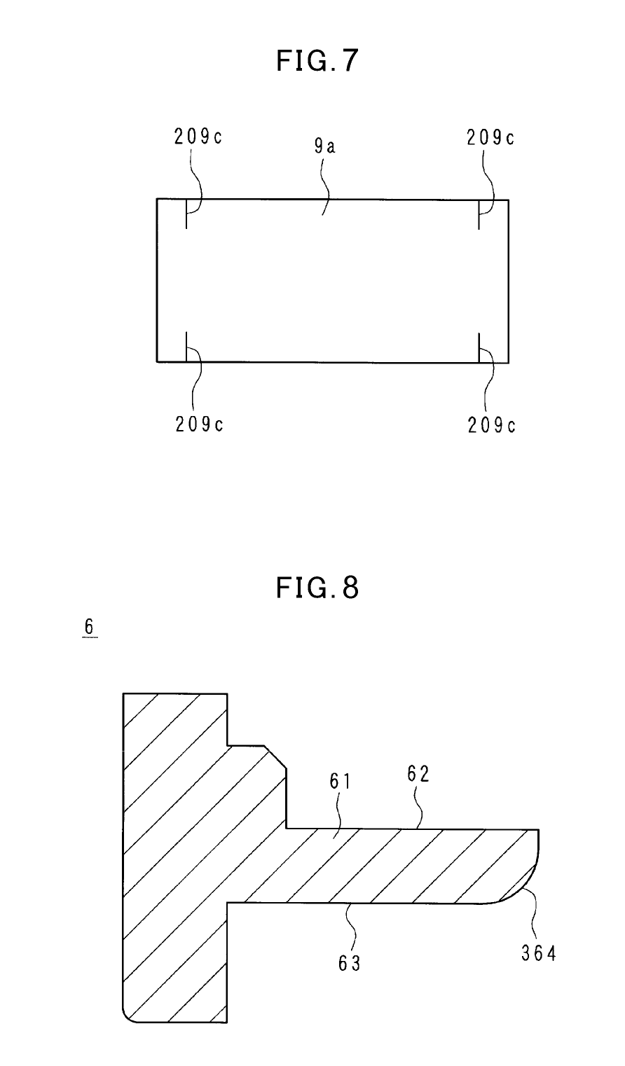

FIG. 7 shows a front view of a second optical sheet 9a according to Embodiment 2. As shown in FIG. 7, linear slits 209c are formed at the long sides from the both long sides along the short sides in the neighborhood of the both short sides of the second optical sheet 9a. In other words, four slits 209c are formed at the peripheral portion of the second optical sheet 9a. These slits 209c at the peripheral portion of the second optical sheet 9a enable the peripheral portion of the second optical sheet 9a to be bent easily in a direction toward the front surface or the rear surface.

According to the exemplary configuration of Embodiment 2, the slits 209c are formed at the peripheral portion of the second optical sheet 9a, and as a result, when the peripheral portion of the second optical sheet 9a is expanded due to thermal expansion and contacts with the inclined surface 64, the peripheral portion of the second optical sheet 9a can be bent more easily. Thus, the effect of Embodiment 1 is advantageously ensured.

### (Variation)

In the exemplary Embodiment 2, the slits 209c are provided at four positions of the peripheral portion of the second optical sheet 9a. However, the embodiments of the present application are not limited to such a configuration. For example, dotted slits 209c may be formed from the both long sides in a direction in parallel with the short sides at the peripheral portions of the short sides. Further, also taking a thermal expansion in a direction in parallel with the short sides of the second optical sheet 9a into account, a plurality of the slits 209c may be provided intermittently along the long sides at the peripheral portions of the long sides. Furthermore, in consideration of expansion along with the diagonal directions, diagonal slits 209c may be provided on the four corners of the second optical sheet 9a. As mentioned above, different variations can be considered with respect to the position, number, length, direction and the like of the slits 209c to be provided on the second optical sheet 9a.

By those embodiments mentioned above, the same effects as in Embodiment 2 can be obtained.

### Embodiment 3

In Embodiment 1, the inclined surface 64 is formed into a flat surface. However, as far as the peripheral portion of the second optical sheet 9a which are expanded due to thermal expansion can bent along the inclined surface 64, the shape of the inclined surface 64 is not limited to such a flat surface. In Embodiment 3, an exemplary embodiment of an inclined surface 364 having a curved surface is described.

FIG. 8 shows a cross-sectional view of a flat plate portion 61 of a panel chassis 6 according to Embodiment 3. In FIG. 8, the upward direction is the front surface of the liquid crystal display apparatus 1. Similar to Embodiment 1, the panel chassis 6 may be a substantially rectangular shaped frame body, and on inner surface, included is a flat plate portion 61 protruding toward the optical sheet laminate 9. The flat plate portion 61 includes a front flat surface (front surface) 62 facing to the front and a rear flat surface (rear surface) 63 facing to the rear.

On the other hand, the flat plate portion 61 has an inclined surface 364 having a curved shape unlike Embodiment 1. The inclined surface 364 is inclined from the front surface 62 of the flat plate portion 61 in the direction away from the optical sheet laminate 9 to the rear surface 63 of the flat plate portion 61 in the same manner as the inclined surface 64 according to Embodiment 1. However, compared to the inclined surface 64 of Embodiment 1, the inclined surface 364 is in a shape of swelling to the inside of the liquid crystal display apparatus 1. Even if the inclined surface 364 is in a curved shape, a space between the inclined surface 364 and the optical sheet laminate 9 can become wider in a direction from the front flat surface 62 toward the rear flat surface 63. Therefore, when the optical sheet laminate 9 is expanded due to thermal expansion, the peripheral portion of the second optical sheet 9a can bend along the inclined surface 364.

According to the exemplary Embodiment 3, even if the inclined surface 364 is in a curved shape, the same effect as in Embodiment 1 is exhibited.

It should be noted that in Embodiment 3, the inclined surface 364 is in a curved shape of swelling toward the inside of the liquid crystal display apparatus 1, but Embodiment 3 is not limited to this configuration. The inclined surface 364 may be formed into a curved surface recessed in a direction toward the outside of the liquid crystal display apparatus 1. Even in this case, the peripheral portion of the second optical sheet 9a expanded due to thermal expansion can bend along the inclined surface 364, and the same effect of Embodiment 3 as mentioned above will be exhibited.

### Embodiment 4

In Embodiment 1, an exemplary embodiment of the display apparatus is described in which the peripheral portion of the second optical sheet 9a expanded due to thermal expansion bends along the inclined surface 64. In Embodiment 4, the inclined surface 464 with a projection and recess portion 465 will be described.

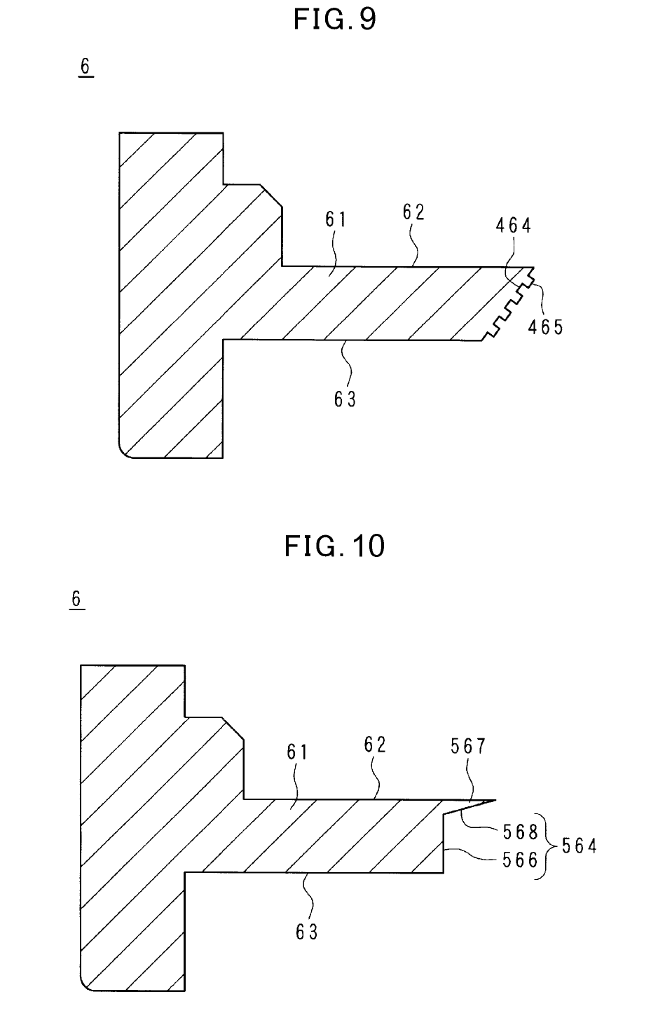

FIG. 9 shows a cross-sectional view of a flat plate portion of the panel chassis 6 according to Embodiment 4. In FIG. 9, the upward direction is the front side of the liquid crystal display apparatus 1. Similar to Embodiment 1, the panel chassis 6 may be a substantially rectangular shaped frame body, and on inner surface, included is a flat plate portion 61 protruding to its center. The flat plate portion 61 includes a front flat surface 62 facing to the front and a rear flat surface 63 facing to the rear. Further, an inclined surface of the flat plate portion 61 is inclined from the front surface 62 of the flat plate portion 61 in the direction away from the optical sheet laminate 9 to the rear surface 63 of the flat plate portion 61.

While the inclined surface 64 according to Embodiment 1 is in a flat shape, the inclined surface 464 according to Embodiment 4 includes a comb-shaped, projection and recess portion 465, in which a projection portion is provided at fixed intervals. On the inclined surface 464, a sum of heights from the inclined surface 464 of the projection portions of the projection and recess portion 465 is about a half of the total length of the inclined surface 464. The projection and recess portion 465 has flexibility. Therefore, when the peripheral portion of the second optical sheet 9a expanded due to thermal expansion contacts with the projection and recess portion 465, a force may be applied to the projection and recess portion 465 from the second optical sheet 9a, but the projection portion of the projection and recess portion 465 can bend along the direction of inclination by the force. Therefore, the projection and recess portion 465 can absorb a pressure caused by a contact between the peripheral portion of the second optical sheet 9a and the inclined surface 464.

In this exemplary embodiment, a sum of heights of the projection portion of the projection and recess portion 465 from the inclined surface 464 is about a half of the total length of the inclined surface 464, however, it should be understood that Embodiment 4 is not limited to such a configuration. As far as the projection and recess portion 465 can absorb a pressure caused by a contact between the peripheral portion of the second optical sheet 9a and the inclined surface 464, the height of each projection portion is not particularly limited.

According to the exemplary Embodiment 4, a pressure caused by a contact between the peripheral portion of the second optical sheet 9a and the inclined surface 464, is absorbed. This enables to avoid the damage to be caused by a contact of the peripheral portion of the second optical sheet 9a with the inclined surface 464, providing the protection of the peripheral portion of the second optical sheet 9a.

It should be noted that the projection and recess portion 465 can be provided not only in the case where the inclined surface 464 is inclined at a fixed angle but also in the case where the inclined surface 464 is not inclined at a fixed angle as indicated by the inclined surface 364 according to Embodiment 3. Even in such cases, the same effect as in this embodiment can be advantageously exhibited.

### Embodiment 5

In Embodiment 1, the exemplary embodiment of the inclined surface 64 in a flat shape is described. In Embodiment 5, the exemplary embodiment of the inclined surface 564 formed in a substantially L-shape in a cross-sectional view is described.

FIG. 10 shows a cross-sectional view of a flat plate portion of the panel chassis 6 according to Embodiment 5. In FIG. 10, the upward direction is the front side of the liquid crystal display apparatus 1. Similar to Embodiment 1, the panel chassis 6 may be a substantially rectangular shaped frame body, and on inner surface, included is a flat plate portion 61 protruding to its center. The flat plate portion 61 includes a front surface 62 facing to the front and a rear surface 63 facing to the rear.

On the other hand, unlike the example of inclined surface 64 according to Embodiment 1, the end surface of the flat plate portion 61 forms the inclined surface 564, which is substantially L-shaped in a cross-sectional view along the direction perpendicular to extending direction of the short side of the panel chassis 6. The inclined surface 564 is composed of an edge 566 of the flat plate portion 61 (hereinafter referred to as a flat plate edge 566), which forms a flat surface facing toward the direction of protrusion of the flat plate portion 61, and a rear surface 568 of a tip portion 567, which protrudes from the flat plate edge 566 toward the center of the liquid crystal display apparatus 1, (hereinafter referred to as a tip portion rear surface 568). The thickness of the tip portion 567 can be significantly thinner than the flat plate portion 61. The front of the tip portion 567 is on the same plane as the front surface 62. Further, the tip portion rear surface 568 is not placed parallel to the front surface 62 of the flat plate portion 61 and is slightly inclined from the front surface 62 in the direction approaching the rear surface 63 of the flat plate portion 61. With this configuration, when the second optical sheet 9a is expanded due to thermal expansion, the peripheral portion of the second optical sheet 9a contacts with the tip portion rear surface 568 first, and then bends along the tip portion rear surface 568. When the second optical sheet 9a is expanded more, the peripheral portion of the second optical sheet 9a contacts with the flat plate edge 566, and then bends along the flat plate edge 566.

According to the presently illustrated Embodiment 5, the peripheral portion of the second optical sheet 9a expanded due to thermal expansion bends along the inclined surface 564 provided with the flat plate edge 566 and the tip portion rear surface 568. Therefore, the same effect as in Embodiment 1 is exhibited.

As described in detail in Embodiments 3 and 5, the shape of the inclined surface 64 is not particularly limited. The inclined surface 64 may be formed in any shapes as long as it is formed to be inclined in a way that a plane formed by connecting an end of the front surface 62 and an end of the rear surface 63 is inclined, enabling the expanded peripheral portion of the second optical sheet 9a due to thermal expansion to bend toward a predetermined direction.

It should be appreciated that the disclosed embodiments are intended to be illustrative and not restrictive in all respects. The scope of the present invention is not limited to the above-described context, and is defined by the claims, and the meaning equivalent to the claims and all modifications within the scope of the claims are intended to be included.

What is claimed is:

1. A liquid crystal display apparatus comprising:
a light guiding plate,
an optical sheet laminate comprising a first optical sheet and a second optical sheet laminated on a light-emitting surface of the light guiding plate, the second optical sheet having a higher coefficient of thermal expansion than that of the first optical sheet,
a liquid crystal panel disposed on the optical sheet laminate and displaying an image on a front surface thereof, and
a panel chassis comprising a flat plate portion, the flat plate portion having a front surface abutting against a circumferential part of a rear surface of the liquid crystal panel and a rear surface abutting against a circumferential part of a front surface of the light guiding plate,
wherein an end surface of the flat plate portion has an inclined surface, the end surface of the flat plate portion being opposed to an end surface of the optical sheet laminate disposed between the light guiding plate and the liquid crystal panel, and
wherein the inclined surface is formed in such a manner that the end surface of the flat plate portion is farther from an end surface of the first optical sheet of the optical sheet laminate than an end surface of the second optical sheet of the optical sheet laminate.

2. The liquid crystal display apparatus of claim 1, wherein the second optical sheet is disposed in the neighborhood of the liquid crystal panel, and the first optical sheet is disposed in the neighborhood of the light guiding plate.

3. The liquid crystal display apparatus of claim 1, wherein a slit is provided at a peripheral portion of the second optical sheet.

4. The liquid crystal display apparatus of claim 3, wherein the second optical sheet is a rectangular sheet having two short sides and two long sides, and the end surface of the second optical sheet opposed to the end surface of the flat plate portion is one of the short sides, and
wherein the slit is formed in the neighborhood of the one of the short sides.

5. The liquid crystal display apparatus of claim 3, wherein the second optical sheet is a rectangular sheet having two short sides and two long sides, and the end surface of the second optical sheet opposed to the end surface of the flat plate portion is one of the short sides, and
wherein the slit is formed in the neighborhood of the one of the short sides from one of the two long sides to the other of the two long sides in a form of a dotted line.

6. The liquid crystal display apparatus of claim 4, wherein the slit is formed substantially in parallel to the short side.
